(19) United States
(12) Patent Application Publication
(10) Pub. No.: US 2011/0129410 A1
(43) Pub. Date: Jun. 2, 2011

(54) METHOD FOR RECYCLING USED LEAD ACID BATTERIES ELECTROLYTIC SOLUTION

(76) Inventor: Almir Dos Santos Trindade, Gov. Valadares (BR)

(21) Appl. No.: 13/056,312

(22) PCT Filed: May 27, 2009
(86) PCT No.: PCT/BR2009/000150

§ 371 Date: Jan. 28, 2011

(30) Foreign Application Priority Data
Jul. 28, 2008 (BR) PI08024995

(51) Int. Cl. C01B 17/90

(52) U.S. Cl. 423/531

(57) ABSTRACT

“METHOD FOR RECYCLING USED LEAD ACID BATTERIES ELECTROLYTIC SOLUTION”, especially the automotive batteries, has the following stages: the sulfuric acid solution derived from the cutting of batteries goes through a drying bed (quick filters) which is composed of a layer of crushed rocks, “bidim” and sand or through a press filter for the retaining of the solid particles, after the solution goes through these filters, it goes through to a reactor where it suffers a forced decantation process for retaining the heavy metals and contaminants; the forced decantation process is carried out by adding 20 liters of aluminum dioxide, 20 kilos of lime (in the form of milk of lime), 2 liters of aluminum polychloride (flocculent) and 200 grams of acrylic acid acrylamide (polymer, used diluted in water) to every 10,000 liters of sulfuric acid under shaking, it is then left at rest for 40 minutes for decantation, soon after decantation the floating part goes through a bag filter with a polyethylene sheet filter and then through a 5-micre cartridge filter, then it is sent to a reservoir and it is stored; the decanted part is sent to the drying beds for retaining the flocculent materials and the percolated one goes to the reprocessing method as described above; when reaching the storage tanks, the solution has low levels of lead, between 3 ppm and 5 ppm. In order to assure a greater safety of the process during the loading of the containers that will carry the recycled product, the solution goes through polyester filters for being sent to the other companies as raw material.

The present patent of invention describes a brand-new recycling process of used batteries sulfuric acid solution, especially the automotive ones, which has an innovative conception and important functional and technological enhancements according to the most modern concepts of chemical engineering and under the required norms and specifications, bringing about its own characteristics and fundamental requirements of novelty and inventive activity, resulting in a number of actual and remarkable technical, practical and economical advantages.

Lead is the fifth highest-volume metal found in the world. Throughout the centuries, due to its physical-chemical properties, this metal has had several applications, being the manufacturing of lead acid batteries for cars the main one.

Lead can be recycled many times thus obtaining a secondary metal which is similar to the processed primary one since the recycling technology is appropriate.

The worldwide level of recycled lead production reaches 70% of the whole used lead.

Considering the specific field of automobile lead acid batteries manufacturing, such percentage gets close to 80%.

Yet, concerning the sulfuric acid solution which is part of the battery, nearly 100% of what is received by the battery recyclers is neutralized and disposed of in water bodies such as rivers, streams, etc., and, in some cases, it is released in natura in the soil causing great environmental damages as, besides contaminating the soil, it also contaminates the underground waters.

As the experts in this issue are aware of, one of the most serious problems of the humankind is the destination of the industrial waste, especially the one generated by components that accumulate energy, such as the automotive lead acid batteries.

Because of this, studies have been carried out throughout the times aiming at the minimization of this problem and, as a result, this process which enables the recycling of the sulfuric acid solution derived from used batteries was developed. It has two main goals, the first one is to obtain the sulfuric acid solution through recycling and the second one is not to damage nature anymore. Thus, the object of the present patent is ecologically correct as it will turn a dangerous toxic waste into raw material to be used in several industrial processes, benefiting both the nature as its natural resources are preserved and the man with cleaner models of production and by keeping their jobs and their income.

### STAGES OF THE PROCESS

The recycling of the electrolytic solution, that is, the sulfuric acid solution derived from used automotive batteries, is a process the presents the following procedures:

The sulfuric acid solution derived from the batteries cutting goes through a drying bed (quick filter) which is composed of a layer of crushed rocks, “bidim” and sand, or through a press filter for retaining the solid particles. After going through the quick filters or the press filter, the solution goes through to a reactor in which it suffers a forced decantation process for decanting the heavy metal and contaminants present in it.

The forced decantation process is carried out as follows: for every 10,000 liters of the sulfuric acid solution under shaking, one must add 20 liters of aluminum hydroxide, 20 kilos of lime (in the form of milk of lime), 2 liters of aluminum polychloride (flocculent) and 200 grams of acrylic acid acrylamide (polymer, used diluted in water), leave it at rest for decantation for 40 minutes; soon after the decantation, the floating part goes through a bag filter with a polyethylene sheet filter and then through a 5 microns cartridge filter and it is then sent to a reservoir where it is stored.

The decanted part is sent to the drying beds for retaining flocculent and decanted materials whereas the percolated part goes through to the reprocessing method as described above.

When getting to the storage tanks, the recycled solution looks transparent and colorless, with low levels of lead, between 3 ppm and 5 ppm. In order to assure the safety of the process during the loading of the containers that will carry the recycled product, the solution goes through polyester filters to be transported to other companies as raw material.

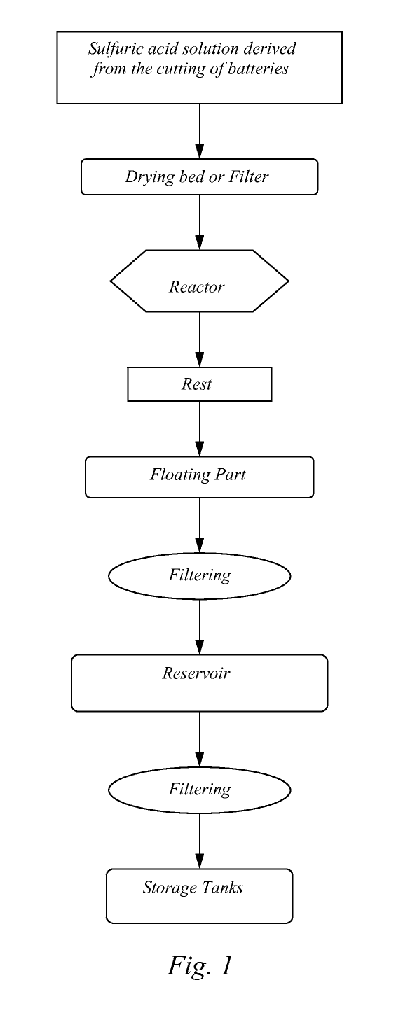

In order to visualize the stages of the aforesaid process for obtaining sulfuric acid from used batteries clearly, a flowing chart represented by FIG. 1 is attached.

No other recycling process of the sulfuric acid from used batteries that gathers all the intrinsic and functional characteristics mentioned above is known to be directly or indirectly as effective as the process which is the object of this patent.

It is, therefore, a process of great relevance to the aimed goal, which consists of a brand new way of obtaining sulfuric acid solution, meeting completely the proposed purposes and fulfilling its functions in a practical and efficient way, providing with a number of advantages which are inherent to its applicability, having its own characteristics that are innovative and provided with fundamental specifications of novelty and inventive activity that are required for receiving the patent of invention protection.

1. “METHOD FOR RECYCLING USED LEAD ACID BATTERIES ELECTROLYTIC SOLUTION”, characterized by the fact that it is composed by the following stages:
The sulfuric acid solution from the cutting of the batteries goes through a drying bed (quick filters) which is composed of a layer of crushed rocks, “bidim” and sand or through a press filter for retaining the solid particles, after the passage through theses filters, the solution goes through to a reactor where it suffers a forced decantation process for retaining heavy metals and contaminants;
The forced decantation process is carried out by adding 20 liters of aluminum hydroxide, 20 kilos of lime (in the form of milk of lime), 2 liters of aluminum polychloride (flocculent) and 200 grams of acrylic acid acrylamide (polymer, used diluted in water) to every 10,000 liters of sulfuric acid solution under shaking, it is left at rest for 40 minutes for decantation and soon after the decantation, the floating part goes through a bag filter with a polyethylene sheet filter and then through a 5 microns cartridge filter and it is eventually sent to a container and it is stored;
The decanted material is sent to the drying beds for the retaining of the flocculated materials and the percolated part goes to the reprocessing method as describe above;
When reaching the storage tanks, the solution presents low levels of lead, between 3 ppm and 5 ppm. In order to assure a greater safety of the process during the loading of the containers that will carry the recycled product, the solution goes through polyester filters for being sent to the other companies as raw material.
